(19) United States
(12) Patent Application Publication
(10) Pub. No.: US 2017/0289945 A1
(43) Pub. Date: Oct. 5, 2017

(54) CONTROL DEVICE, NETWORK DEVICE AND METHODS THEREOF

(71) Applicant: HUAWEI TECHNOLOGIES CO., LTD., Shenzhen (CN)

(72) Inventors: Kari Juhani Leppanen, Helsinki (FI); George Koudouridis, Kista (SE); Henrik Lundqvist, Kista (SE)

(73) Assignee: HUAWEI TECHNOLOGIES CO., LTD., Shenzhen (CN)

(21) Appl. No.: 15/624,007

(22) Filed: Jun. 15, 2017

Related U.S. Application Data
(63) Continuation of application No. PCT/EP2014/077939, filed on Dec. 16, 2014.

(51) Int. Cl. H04W 60/04; H04W 8/26

(52) U.S. Cl. CPC H04W 60/04; H04W 8/26

(57) ABSTRACT

The control device (100) comprises a processor (101) and a transceiver (103); wherein the transceiver (103) is configured to receive a network address signal comprising an assigned network address for the control device (100) in a radio access network (500); wherein the processor (101) is configured to generate a registration message indicating the assigned network address for the control device (100) and one or more network identities for a user device (600) connected to the radio access network (500); wherein the transceiver (103) further is configured to transmit a registration signal comprising the registration message to a network device (300), receive a user information signal at the assigned network address, the user information signal comprising network operation information for the user device (600); and wherein the processor (101) further is configured to determine a network control decision for the user device (600) based on the network operation information.

### CROSS-REFERENCE TO RELATED APPLICATIONS

This application is a continuation of International Application No. PCT/EP2014/077939, filed on Dec. 16, 2014, the disclosure of which is hereby incorporated by reference in its entirety.

### TECHNICAL FIELD

The present invention relates to a mobility control device and a network device. Furthermore, the present invention also relates to corresponding methods, a computer program, and a computer program product.

### BACKGROUND ART

Interworking of wireless cellular systems and WiFi networks is becoming an important issue. For example, the Hotspot 2.0 specification from the WiFi Alliance is addressing the problem how to allow offloading of data traffic from cellular networks to the WiFi networks of the same operator. As the number of WiFi access operators and 5G access network operators is large, in future it will be critical to define proper methods for handover between networks operated by different operators.

A conventional solution for handover has been proposed where a Software Defined Networking (SDN) Framework for enterprise Wireless Local Area Networks (WLANs) is proposed. This conventional solution builds on a light virtual Access Point (AP) abstraction, which allows the infrastructure to move clients to different APs. The architecture consists of a single Master and multiple Agents running on each AP. The master, implemented on top of an OpenFlow controller, has a global view of the network in terms of clients, flows, and infrastructure. The Agents allow multiple clients to be treated as a set of logically isolated clients connected to different ports of a switch. A central primitive of the conventional solution is the Light Virtual Access Point (LVAP). The LVAP decouples association/authentication from the physical connection between clients and AP. With LVAPs every client that tries to associate to the WLAN receives a unique Basic Service Set Identifier (BSSID), i.e. every client is given the illusion of having a dedicated AP. Similarly, each physical AP hosts an LVAP for each connected client. Therefore, migrating an LVAP between two physical APs, effectively results in client handover without requiring any re-association and re-authentication.

Deployments of modern wireless networks, capillar or cellular, are in the order of hundred of even thousand (access) network nodes, serving a multitude of client (user) devices such as smart-phones, laptops or tablets. Scalability in this context is paramount. What most wireless deployments have in common is the support for features such as Authentication, Authorization and Accounting (AAA), policy management, mobility management, interference management with dynamic channel reconfigurations or client re-associations, load balancing and providing quality of service guarantees. The management is usually centralized and proprietary. Such a centralized management leads to proprietary network domains and restricts the efficient utilization of the available wireless resources as compared to a radio access environment that integrates different radio access technologies, networks, and operators.

Such an integrated radio access environment is beneficial for both users and providers. From a user's perspective integrated radio environments in the prior art targeted to provide automation for seamless vertical handovers between APs and service continuity for the users based on the flexibility of choosing the best access points (and operators) for users' services. From the service provider perspective such a radio environment would imply better service to users. For the access operators, it would lead to better usage of system resources and an increase in system capacity. However, it is not obvious how to devise such an open cooperative radio environment that optimise for service providers, network operators and the user devices, while removing any relation of ownership or subscription.

### SUMMARY

An objective of embodiments of the present invention is to provide a solution which mitigates or solves the drawbacks and problems of conventional solutions.

Another objective of embodiments of the present invention is to provide an efficient solution for handling different network control decisions for user devices in wireless communication systems.

An “or” in this description and the corresponding claims is to be understood as a mathematical OR which covers “and” and “or”, and is not to be understand as an XOR (exclusive OR).

The above objectives are solved by the subject matter of the independent claims. Further advantageous implementation forms of the present invention can be found in the dependent claims.

According to a first aspect of the invention, the above mentioned and other objectives are achieved with a control device for a wireless communication system, the control device comprising a processor and a transceiver;

wherein the transceiver is configured to receive a network address signal S₁ comprising an assigned network address for the control device in a radio access network;

wherein the processor is configured to generate a registration message indicating the assigned network address for the control device and one or more network identities for a user device connected to the radio access network;

wherein the transceiver further is configured to transmit a registration signal S₂ comprising the registration message to a network device,

receive a user information signal S₃ at the assigned network address, the user information signal S₃ comprising network operation information for the user device; and

wherein the processor further is configured to determine a network control decision for the user device based on the network operation information.

The network operation information for a user device includes information that is useful for the control decision, for example radio channel information and service requirements. This information may come from different entities, for example the user device itself or network entities handling the quality of service policies of the user device. By processing the incoming information the control device can make a control decision that allows the services of the user device to operate well.

With a control device configured to register with the present registration message and determine a network control decision for the user device according to implementation forms of the present invention a number of advantages are provided.

The control functionality for a user device can be placed more flexibly within the network with the present control device. Since the network assigns an address to the control device it is possible to assign user specific control devices at arbitrary locations in the network. The address allows the control device to be located or found regardless of how it is implemented, e.g. it may have its own virtual machine or it may be a software process running in a server. The network devices that need to interact with the control device for a user device will be able to reach the control device regardless of where the control device is located by addressing transmissions to the assigned network address. The control device will be receiving the signals address to it e.g. by listening on a transport layer port that is assigned in the network address, e.g. as a daemon.

Therefore, the control functions can be moved to different locations in the network to optimize the performance for the user devices that require high performance and to minimize the signalling for the user devices that do not require very high performance in terms of low service disruption time and optimal selection of access node.

The present control device can also be implemented as a software agent with ability to copy itself or move to new locations within the network. This allows autonomous operation of control software related to a user device. It also allows different organizational entities, such as service providers and network operators, to have their own control software running in the networks of other organizations. This has the advantage that the solution gives better possibilities to implement its own policies. Such policies may be used to reduce processing load and power consumption for user devices or to implement preferred roaming policies.

Another advantage with the present control device is that it enables the user management and the network management to be effectively separated. Furthermore, service providers have the possibility, by means of control devices, to negotiate in parallel with operators at multiple network tiers, such as core network operators, backhaul network operators and radio access operators, to tailor an end-to-end and/or end-to-edge transmission path for their user devices.

Another advantage is that the integration of core, (wireless or wired) backhaul and radio access networks can be done dynamically by means of negotiations between service provider and any Core Network Operator (CNO), Backhaul Network Operator (BNO) and Radio Access Operator (RAO).

In a first possible implementation form of the control device according to the first aspect, the processor further is configured to determine the network control decision by executing a control algorithm.

An advantage with this implementation form is that a specific control algorithm can be used for the control of each user device.

In a second possible implementation form of the control device according to the first implementation form of the first aspect, the transceiver further is configured to receive a first control signal from a service provisioning device, wherein the first control signal comprises control instructions for the execution of the control algorithm.

An advantage with this implementation form is that the control algorithm can be changed, which allows for example a service provider to modify how the service of its customers is provided in a radio access network.

In a third possible implementation form of the control device according to any of the preceding implementation forms of the first aspect or to the control device as such, the control decision is a mobility decision for the user device.

An advantage with this implementation form is that mobility control is an important function for the service of user devices, which can be controlled efficiently using the current solution. The mobility policies include e.g. which radio access network a user device connects to and when the user device changes radio access network.

In a fourth possible implementation form of the control device according to any of the preceding implementation forms of the first aspect or to the control device as such, the transceiver further is configured to transmit a second control signal to a network controller of the radio access network or to the user device, the second control signal comprising the control decision for the user device.

An advantage with this implementation form is that the control device can execute the control decision with the help of the radio access network and the user device.

In a fifth possible implementation form of the control device according to any of the preceding implementation forms of the first aspect or to the control device as such, the network operation information for the user device is one or more in the group comprising: network location information, positioning information for the user device, radio channel measurement information, channel quality information, battery state information of the user device, quality of service information for the user device, charging information, encryption information, authentication information, and network mobility policy information.

An advantage with this implementation form is that this network operation information allows the control device to take a decision based on multiple relevant information classes to meet the objective set out in this disclosure.

According to a second aspect of the invention, the above mentioned and other objectives are achieved with a network device for a wireless communication system, the network device comprising a processor, a transceiver and a database;

wherein the transceiver is configured to receive a registration signal S₂ comprising a registration message indicating a network address of a control device for a user device and one or more network identities of the user device; and

wherein the processor is configured to update a database object for the user device in the database with the registration message.

With a network device configured to receive the present registration message and updating a locator database according to implementation forms of the present invention a number of advantages are provided.

One advantage is that the present network device keeps a database that allows the network device to map user device identities to the location/position of the control device responsible for the specific user device. It is therefore possible for other entities in the wireless communication system to find the control device at its current location in the wireless communication. This allows a very flexible placement of control functionality. In current networks the placement of control functionality is typically limited to specific dedicated control entities, such as mobility management entities (MME), etc. The current solution allows control functionality to be placed more freely, which supports implementation of virtualized network functionality on both large-scale centralized computing platforms and distributed small-scale platforms.

In a first possible implementation form of the network device according to the second aspect, the processor further is configured to use the one or more network identities of the user device as lookup indices in the database.

An advantage with this implementation form is that the network entity that needs to contact the control device only needs to know a user device identity to be able to find the related control device. The user device identity can be communicated by a device that tries to connect to a radio access network, and the radio access network can find the related control device.

In a second possible implementation form of the network device according to the first implementation form of the second aspect or to the network device as such, the database object in the database further comprises

a first database entry indicating the network address of the control device, and

a second database entry indicating a mobility anchor point of the user device.

An advantage with this implementation form is that a network entity may locate both the control plane entity responsible for the user device and the data plane anchor point for the user device. Both control plane functionality for the user device and data forwarding can therefore be achieved based on the responses from the present network device.

In a third possible implementation form of the network device according to any of the preceding implementation forms of the second aspect or to the network device as such, the database object further comprises

a third database entry indicating an identity associated with a control plane of the user device, and

a fourth database entry indicating an identity associated with a data plane of the user device.

An advantage with this implementation form is that the entity looking up the addresses can use either an identity related to the control plane or an identity related to the data plane. The entities looking up the address may be e.g. a base station where the user device is trying to connect, or a host which is trying to communicate with the user device. In some embodiments the dual identities has the advantage that the entity only needs to know one identity. In other embodiments it has the advantage that the present network device replies with the mobility anchor address if the present network device receives a request with the data plane identity, while the present network device replies with the control device address if the present network device receives a request with the control plane identity.

In a fourth possible implementation form of the network device according to the third implementation form of the second aspect, the fourth database entry is an encrypted identity of the user device.

An advantage with this implementation form is that the control process may have to be contacted prior to any communication with the user device to get the data plane identity. This would be beneficial for control of billing, authentication, authorization and other setup related processes required for the establishment of a flow or session or connection to/from a user device.

In a fifth possible implementation form of the network device according to any of the preceding implementation forms of the second aspect or to the network device as such, the network address of the control device comprises an IP-address and a transport layer port number (e.g. a Transmission Control Protocol (TCP) port number).

An advantage with this implementation form is that the control device can be located in any Internet connected computer, and the software process handling the specific user device can be reached through the port number.

According to a third aspect of the invention, the above mentioned and other objectives are achieved with method for a wireless communication system, the method comprising:

receiving a network address signal S₁ comprising an assigned network address for the control device in a radio access network;

generating a registration message indicating the assigned network address for the control device and one or more network identities for a user device connected to the radio access network;

transmitting a registration signal S₂ comprising the registration message to a network device,

receiving a user information signal S₃ at the assigned network address, the user information signal S₃ comprising network operation information for the user device;

determining a network control decision for the user device based on the network operation information.

In a first possible implementation form of the method according to the third aspect, the method further comprises determining the network control decision by executing a control algorithm.

In a second possible implementation form of the method according to the first implementation form of the third aspect, the method further comprises receiving a first control signal from a service provisioning device, wherein the first control signal comprises control instructions for the execution of the control algorithm.

In a third possible implementation form of the method according to any of the preceding implementation forms of the third aspect or to the method as such, the control decision is a mobility decision for the user device.

In a fourth possible implementation form of the method according to any of the preceding implementation forms of the third aspect or to the method as such, the method further comprises transmitting a second control signal to a network controller of the radio access network or to the user device, the second control signal comprising the control decision for the user device.

In a fifth possible implementation form of the method according to any of the preceding implementation forms of the third aspect or to the method such, the network operation information for the user device is one or more in the group comprising: network location information, positioning information for the user device, radio channel measurement information, channel quality information, battery state information of the user device, quality of service information for the user device, charging information, encryption information, authentication information, and network mobility policy information.

According to a fourth aspect of the invention, the above mentioned and other objectives are achieved with method for a wireless communication system; the method comprising

receiving a registration signal S₂ comprising a registration message indicating a network address of a control device for a user device and one or more network identities of the user device; and

updating a database object for the user device in the database with the registration message.

In a first possible implementation form of the method according to the fourth aspect, the processor further is configured to use the one or more network identities of the user device as lookup indices in the database.

In a second possible implementation form of the method according to the first implementation form of the fourth aspect or to the method as such, the database object in the database further comprises

a first database entry indicating the network address of the control device, and

a second database entry indicating a mobility anchor point of the user device.

In a third possible implementation form of the method according to any of the preceding implementation forms of the fourth aspect or to the method as such, the database object further comprises

a third database entry indicating an identity associated with a control plane of the user device, and

a fourth database entry indicating an identity associated with a data plane of the user device.

In a fourth possible implementation form of the method according to the third implementation form of the fourth aspect, the fourth database entry is an encrypted identity of the user device.

In a fifth possible implementation form of the method according to any of the preceding implementation forms of the fourth aspect or to the method as such, the network address of the control device comprises an IP-address and a transport layer port number.

The advantages of the methods according to the third aspect and the fourth aspect are the same as those for the corresponding device claims according to the first and second aspects.

The present invention also relates to a computer program, characterized in code means, which when run by processing means causes said processing means to execute any method according to the present invention. Further, the invention also relates to a computer program product comprising a computer readable medium and said mentioned computer program, wherein said computer program is included in the computer readable medium, and comprises of one or more from the group: ROM (Read-Only Memory), PROM (Programmable ROM), EPROM (Erasable PROM), Flash memory, EEPROM (Electrically EPROM) and hard disk drive.

Further applications and advantages of the present invention will be apparent from the following detailed description.

### BRIEF DESCRIPTION OF DRAWINGS

The appended drawings are intended to clarify and explain different embodiments of the present invention, in which:

FIG. 1 shows a control device according to an embodiment of the present invention;

FIG. 2 shows a method according to an embodiment of the present invention;

FIG. 3 shows a flow chart of a method according to an embodiment of the present invention;

FIG. 4 shows a network device according to an embodiment of the present invention;

FIG. 5 shows another method according to an embodiment of the present invention;

FIG. 6 shows a database object according to an embodiment of the present invention;

FIG. 7 shows another flow chart of a method according to an embodiment of the present invention;

FIG. 8 illustrates interaction between different communication entities in a wireless communication system according to an embodiment of the present invention;

FIG. 9 illustrates an embodiment of a wireless communication system according to the present invention; and

FIG. 10 illustrates another embodiment of a wireless communication system according to the present invention.

### DESCRIPTION OF EMBODIMENTS

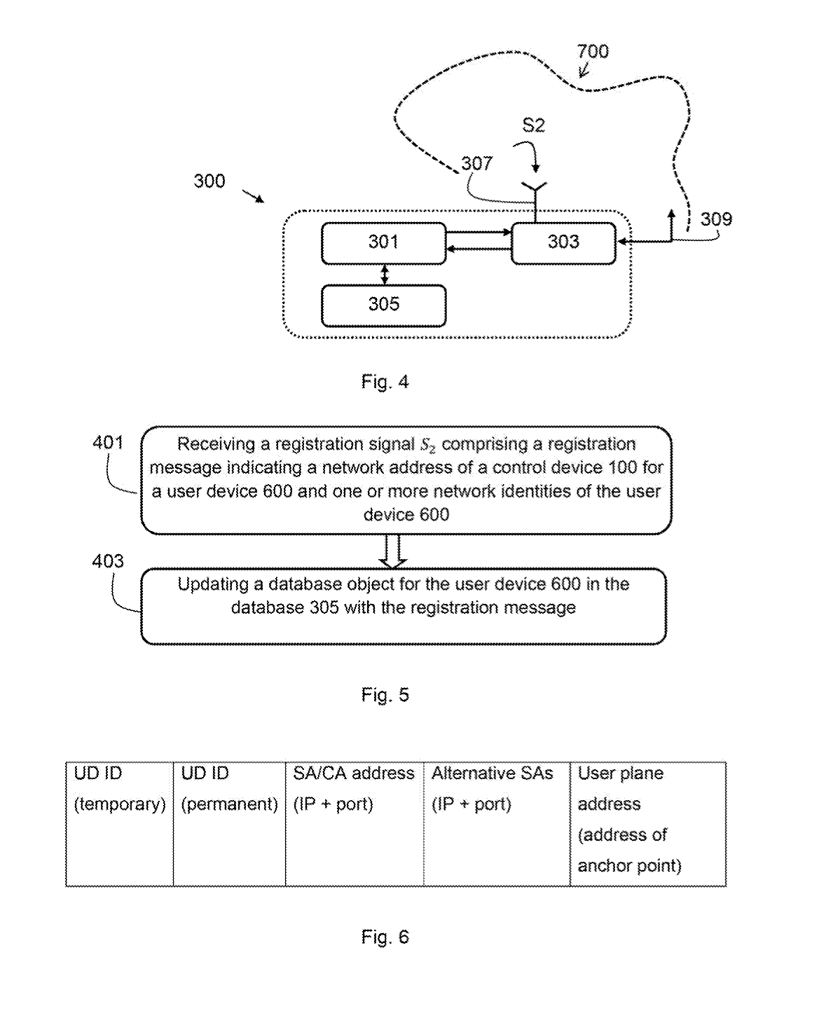

FIG. 1 shows an embodiment of a control device 100 according to the present invention. The control device 100 comprises a transceiver 103 which in this example is coupled to an antenna unit 105 for wireless communication and/or a wired connection 107 for wired communication. The transceiver 103 is configured to receive a network address assignment signal S₁ by means of the antenna unit 105 and/or the wired communication connection 107. The transceiver 103 is further configured to forward the received network address assignment signal S₂ to the processor 101 which means that the processor 101 and the transceiver 103 are communicably coupled to each other with suitable communication means known in the art. The communication means are illustrated with the two arrows between the processor 101 and the transceiver 103 in FIG. 1. The processor 101 is configured to receive the network address assignment signal S₁ and is further configured to generate a registration message which indicates the assigned network address for the control device 100. The registration message also indicates one or more network identities for a user device 600 that is connected to a radio access network (not shown in FIG. 1). The registration message is transmitted in a registration signal S₂ to a network device 300 (see FIG. 4) of a radio communication network. Thereby, the control device 100 has registered itself in the wireless communication system 700.

The transceiver 103 is further configured to receive a user information signal S₃ at the assigned network address, which means that the user information signal S3 is transmitted to the mentioned assigned network address of the control device 100. The user information signal S₃ comprises network operation information for the user device 600. The processor 101 is further configured to determine a network control decision for the user device 600 based on the network operation information.

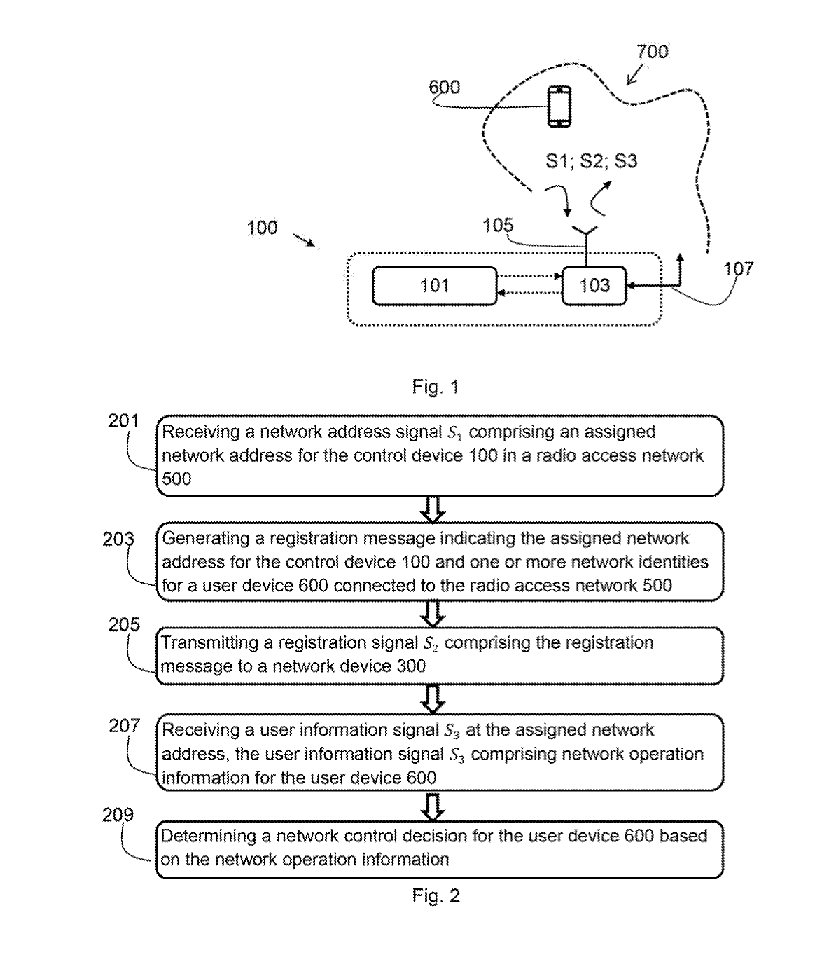

FIG. 2 shows a corresponding method 200 which in this embodiment is executed in a control device 100 shown in FIG. 1. The method comprises a first step 201 of receiving a network address signal S₁ comprising an assigned network address for the control device 100 in a radio access network. The method further comprises a second step 203 of generating a registration message indicating the assigned network address for the control device 100 and one or more network identities for a user device 600 connected to the radio access network. The method further comprises a third step 205 of transmitting a registration signal S₂ comprising the registration message to a network device 300. The method further comprises a fourth step 207 of receiving a user information signal S₃ at the assigned network address, the user information signal S₃ comprising network operation information for the user device 600. The method further comprises a fifth step 209 of determining a network control decision for the user device 600 based on the network operation information.

For the control device 100 being able to make control decisions for the user device 600 the network operation information for the user device 600 is at least one or more in the group comprising: network location information, positioning information for the user device 600, radio channel measurement information, channel quality information, battery state information of the user device 600, quality of service information for the user device 600, charging information, encryption information, authentication information, and network mobility policy information.

The control decision for the user device 600 relates to network operation aspects of the user device 600 in the wireless communication system 700. The control decisions typically configure or reconfigure some aspects of the services that are provided to the user device 600. For example, the control decision may control the configuration of new service sessions during the setup or modification of ongoing service sessions, for example due to mobility. Examples of possible control decisions are given in the following disclosure but are not limited to the following examples.

Resource control: the control decision relates to the amount of communication resources for the user device 600. A control decision in this case may be to request a higher quality of service class, or to request a higher bit rate for the service.

Positioning control: the control decision relates to positioning control for the user device 600. The control device 100 can use the device specific signals (e.g. radio measurements) to estimate the position of the user device 600 in a geographical area. The control decision in this case could be to request further measurements (if the accuracy of the position is not sufficient) or to report the position to an external network entity if the position is accurate enough.

Monitoring control: the control decision relates to monitoring of quality parameters for the user device 600. This would e.g. give a service provider the possibility to monitor that service level agreements are kept by an access network operator. A control decision in this case could be to report a service level problem to an external entity (e.g. a service provider network management server) and to deliver logged data when needed.

Security control: the control decision relates to security aspects for the user device 600. The control device 100 may handle security functionality, such as encryption. The control decision may be to change the encryption key, e.g. if the type of service changes.

Network traffic control: the control decision relates to network traffic control for the user device 600. The control device 100 may control that traffic policies provided by the service provider is maintained. The control decision may be to change parameters related to quality of service policies that are applied in the radio access network.

Mobility control: the control decision relates to mobility control for the user device 600. Based on input data such as radio measurements of different radio access networks the control device 100 may take a decision to change network or to remain connected in the same radio access network.

According to an embodiment of the present invention the processor 101 of the control device 100 further is configured to determine the network control decision by executing a control algorithm. The control algorithm may be software run in the processor 101 of the control device 100.

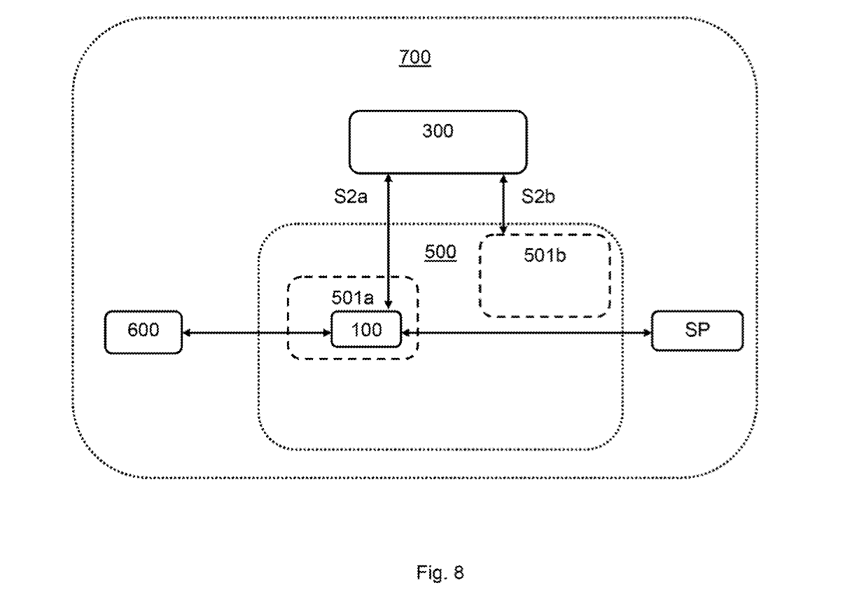

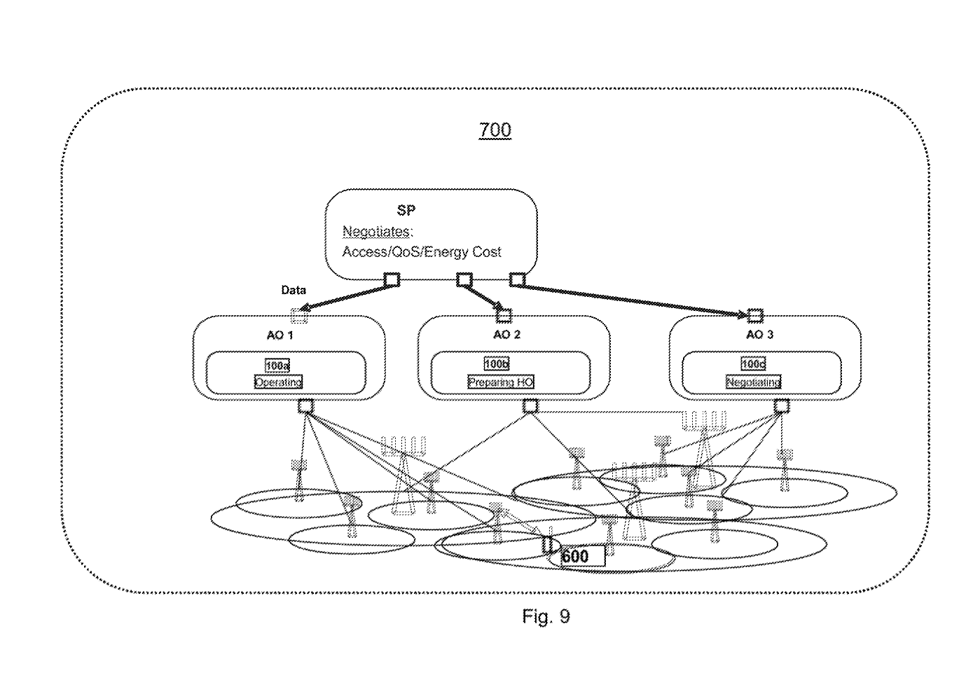

The output of the control algorithm, i.e. the control decision may, according to an embodiment, be transmitted in a second control signal S_{c2} to a network controller 501 (see FIG. 8) of the radio access network or to the user device 600.

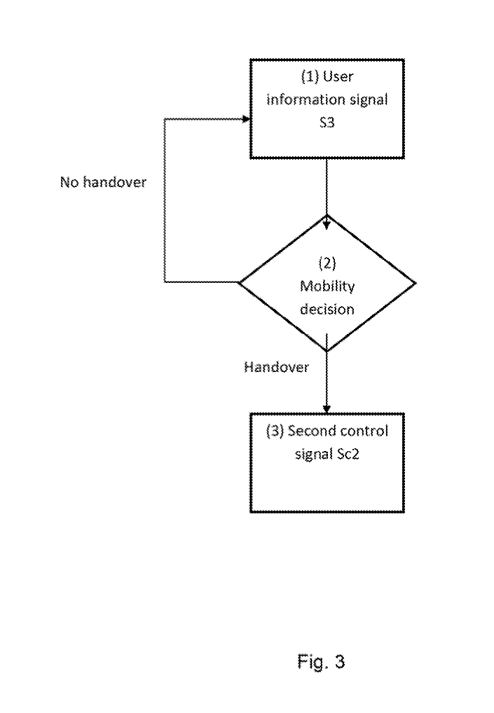

FIG. 3 shows a flow chart of a method in a control device 100 according to the present invention which is configured for handling mobility for the user device 600 in the wireless communication system 700, which means that the control decisions are mobility decisions in this example. In the first step (1) the control device receives a user information signal S₃ that is relevant for the mobility decision. The user information signal S₃ may come from the user device 600 itself or it may come from other network devices. In the second step (2) the control device 100 makes a mobility decision. If it decides not to make any handover the control device 100 will wait for new user information signals and go back to step one (1) before the control device 100 takes a new mobility decision. If the mobility decision is to make a handover the control device 100 sends a control signal in step three (3) to a network control node or to the user device 600, depending on how the handover process is implemented for the specific access networks that are being used.

A general idea of embodiments of the present invention is to make well-optimized and fast control decisions between different radio access networks by means of a control device 100 that operates on behalf of a user device 600 in e.g. controllers of different local radio access networks. The different radio access networks may support the same RAT or different RATs. Therefore, the user device 600 communicates with the control device 100 and sends reports about, e.g. QoS, location and radio measurements to the control device. The control device 100 can implement algorithms that handle multiple RATs according to the policies of a service provider that provides the user device with services. To support a variety of algorithms the user device 600 may also receive instructions about measurement configurations, and control instructions from the control device 100 according to another embodiment of the present invention. This allows the control device 100 to instruct the user device 600 to report the right information for the algorithms the control device 100 is using.

According to another embodiment of the present invention the control device 100 (e.g. in a form of a software agent) may be received from, and authorized by a Service Provider (SP) that has knowledge of the position of the user device 600 and also about the local radio access networks in the location in which the user device 600 is located. The user device would have a contract with the SP, which provides the service(s) to the user device 600 over one or more radio access networks. The different instances of the control devices 100 that are running in different radio access networks may communicate through communication interfaces between network controllers of different independent Network Operators (NOs). This allows very fast control decision to be made (e.g. mobility decisions such as handover) by the control device 100 that only is concerned about the user device 600 and not the business goals of the different operators.

Hence, the control device 100 is associated with a SP according to this embodiment of the present invention. Further, the SP may have a repository of code that is used in the initiation of the control device 100 in the access network. The repository may contain code that implements different control algorithms, so that the control device 100 can be configured with the algorithms that are suitable for the specific user device 100 and a specific scenario. This may be implemented by the SP transmitting first control signals to the control device 100. The first control signals comprise control instructions for the execution of the control algorithm. Hence, the SP can control the executing of the control algorithm by transmitting a first control signal to the control device 100 which receives the first control signal and derives the control instructions for the execution of the control algorithm in the first control signal.

To keep track of the location of all control devices 100a, 100b, . . . , 100n (see FIG. 9) related to a specific user device 600 in a wireless communication system 700 one solution is to rely on functionality in the control devices 100a, 100b, . . . , 100n themselves and in the SP. The location of nearby control devices 100a, 100b, . . . , 100n could be requested from the SP, or distributed between control devices 100a, 100b, . . . , 100n whenever a control device 100 moves or is duplicated. This solution may be rather complex to guarantee robustness when multiple control devices 100a, 100b, . . . , 100n move simultaneously.

Another solution is to rely on a method external to the control devices 100a, 100b, . . . , 100n to keep track of the location of other control devices 100a, 100b, . . . , 100n. In particular, a solution that does not rely on the SP or the control device 100 to locate other control device instances can more easily support that there may be a default handling for some user devices while other user devices have a dedicated control device 100. The solution would then require that the control handling process for each user device 600 can be found, regardless of whether it the control node 100 a dedicated control device 100, a control node 100 in the radio access network or a control node 100 in the SP. This solution should also allow a network node to locate the network controller in the case when a user device 600 connects to the network node and there is no control device 100 installed in the radio access network, or where there may be multiple possible controllers where the control device 100 could be installed. It is therefore useful to support reactive methods to locate the control device 100, regardless of where the control device 100 is located. Since there may be multiple instances of control devices 100a, 100b, . . . , 100n there is also a need to find the right control device 100. Therefore a (distributed) locator database 305 is proposed, where the process that is handling the network control for a specific user device 600 is registered with e.g. a routable address.

According to an embodiment of the present invention the control device 100 is configured to communicate with a locator database 305 of a network device 300 for registering its address and one or more identities of the user device 600 as shown in FIG. 4. The control device 100 may also be configured to request addresses of other control device(s) instances in the system. With such a locator database 305 network controllers or other network nodes of communication networks may send requests to the locator database 305 to find the control device(s) 100 responsible for a specific user device 600.

In this respect FIG. 4 shows an embodiment of a network device 300, e.g. an enhanced Domain Name Server (DNS), a location mapping server, or a gateway node, comprising a (locator) database 305 according to the present invention. The network device 300 comprises a processor 301, a transceiver 303 and a locator database 305. The transceiver 303 is configured to receive a registration signal S₂ by means of e.g. an antenna unit 307 and/or a wired communication connection 309 as shown in FIG. 4. The transceiver 303 may also be configured to transmit one or more signals in the wireless communication system 700.

The registration signal S₂ comprises a registration message indicating a network address of a mobility control device 100 associated with a user device 600 and one or more network identities of the user device 600. The transceiver 303 is further configured to forward S₂ to the processor 301 which means that the processor 301 and the transceiver 303 are communicably coupled to each other. This is illustrated with the two arrows between the processor 301 and the transceiver 303 in FIG. 4.

The processor 301 is configured to receive the registration signal S₂ and is further configured to update a database object associated with the user device 600 in the locator database 305. The mentioned database object is updated with the network address of the control device 100 and the one or more network identities of the user device 600. The database object should be seen as a mapping between the user device 600 Identity (ID) and the location of the control device 100 that is responsible for handling the user device 600. The locator database 305 can contain rules for how to provide the control device address based on different parameters, such as the location of the user device 600 or of the entity that is requesting the address. Since the locator database 305 is updated with every reception of a registration message the locator database 305 needs to be designed to handle such changes efficiently.

FIG. 5 shows a corresponding method which in this example is executed in a network device 300 shown in FIG. 4. The method comprises a first step 401 of receiving a registration signal comprising a registration message indicating a network address of a control device 100 associated with a user device 600. The registration message also comprises one or more network identities of the user device 600. The method further comprises a second step 403 of updating a database object in the locator database 305 with the registration message. The database object is for the user device 600.

FIG. 6 shows an example of a database entry of the database object according to an embodiment of the present invention. One or more identities/identifiers for a user device 600 are used as index to lookup the address of the associated control device 100. The user device identities (IDs) may be of different types, and in particular both temporary and permanent IDs may be available in the database entry. The control device 100 address (i.e. the assigned address) will typically consist of both an IP address and a port number, which allows a network controller, where the control device 100 may be located, to direct the communication to the control device 100 to the right control process.

There may also be more than one control device 100 listed in the locator database 305. In this case the locator database 305 may return more than one address when the control device 100 of a user device is requested. In some cases also other information may be stored in the locator database 305, e.g. related to the user location, or addresses for reachability of the user device over the data plane, etc.

In one embodiment of the present invention the locator database 305 is a Dynamic Delegation Discovery System (DDDS) database. The DDDS database server takes a user device ID in the form of a text string, <UNdID>, and tries to resolve it among the registered user device IDs it has in its local database. The text string <UNdID> may have multiple parts that indicate a hierarchical address structure, e.g. <RNTI.ANd-ID.ANw.SP>, where the order of the parts indicates a typical order of address scope, e.g. a RNTI for the user device, the access node ID where it is connected, the access network identifier of the network it is connected to and the service provider it belongs to. If a database cannot resolve the ID based on the smaller scope IDs it may refer the resolution of the request to another database server in the hierarchy, based on the later parts of the request. This can be done recursively or iteratively. If the database server cannot resolve the ID the database server returns a notification to the requestor.

In another embodiment of the present invention the locator database 305 may keep two further types of user device IDs, a first type relating to the control plane (e.g. an identity that is known only to operators, and maybe to service providers; e.g. an International Mobile Subscriber Identity (IMSI), a Temporary Mobile Subscriber Identity (TMSI), a Radio Network Temporary Identity (RNTI) or a network internal IP-address, a private IP address) and a second type relating to the data plane (e.g. an identity which is needed to reach the user device, i.e. to send data to the user device; e.g. an external IP-address, user ID or a phone number). In this case, a lookup for the control plane related ID would return the address of the control process while a lookup for the data plane ID would return a path or the address of a data plane anchor point. An advantage of this embodiment is that nodes external to the SP and radio access network may have knowledge only of the data plane address, and only get the address to the data plane anchor point, which reduces the possibility for attacks on the control plane nodes.

In another embodiment of the present invention the second type of user device identity relating to the data plane corresponds to an encrypted user device ID. In this case, communicating with this user would require two major steps. In the first step, the control process, i.e., control device 100 is contacted to retrieve the decryption key of user device 600 data plane identity. Then the decryption is applied on the encrypted user device 600 data plane identity to derive the address of the data plane anchor point. An advantage of this embodiment is that to get the address to a user device 600 it would require, apart from a lookup for the user device 600 address in the locator database 305, that the control process is contacted prior to any communication with the user device 600. This would be beneficial for control of billing, authentication, authorization and other setup related processes required for the establishment of a flow or session or connection to/from a user device.

In another embodiment of the present invention the locator database 305 keeps two types of location entries related to each user device, namely:

A first entry identifying a process that handles the mobility control (control plane) of the user device 600; and

A second entry indicating the data plane anchor point of the user device 600.

In an Evolved Packet System (EPS) network the control plane entity would typically be the MME, although in connected mode the serving eNodeB would handle some parts of the functionality that the (mobility) control device 100 implements. The data plane anchor point is typically a Serving Gateway (SGW) in EPS. By keeping both of the addresses in the locator database 305 the requesting entity may reach either of the control plane or mobility anchor directly with a single lookup, without the restriction of implementing them in MME or SGW.

When an instance (e.g. a control device 100) is generated for the purpose of handling mobility for a certain user device 600, the user device 600 registers its address in the locator database 305 by sending a registration message to the locator database 305, i.e. a user device registration message. Generation of control device 100 instances may occur when a user device 600 is moving or changing its service usage, so that a control device 100 at a new location is preferred from a performance point of view, or to reduce the signalling load. A new instance is than instantiated, this may be implemented by starting a new software process in a new location.

A user device registration message includes the network address of the control device 100 (e.g. IP address and port numbers of a server), one or more Identities (IDs) of the user device 600 and the IDs may be temporary or permanent and/or have a global or local scope. The IDs may relate to the network of the control device 100 and/or the user device 600 and location information within the radio access network, e.g. cell ID, base station ID, MME ID, etc. When a network node needs to identify the control device 100 of a user device 600 the network node uses an ID of the user device 600 as a lookup key in the locator database 305.

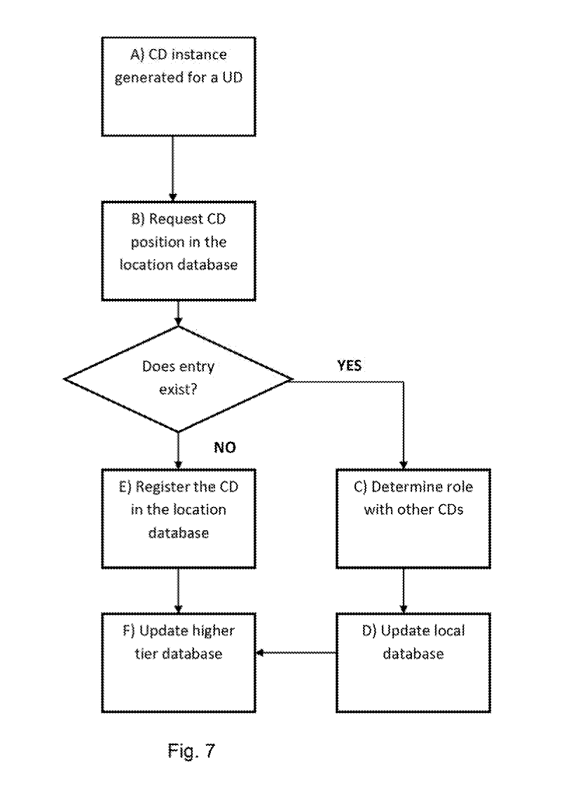

FIG. 7 illustrates an exemplary procedure for initiating a new instance of a Control Device (CD) 100 and the interaction with the locator database 305. At step A) an instance of a control device 100 is generated for a specific User Device (UD) 600. This may be triggered by the SP when the SP sees an opportunity for the user device 600 to connect to an access network and therefore starts a control device 100 in a Network Controller (NC) of the radio access network.

The control device 100 may itself then request the control device 100 location for its own user device ID from the locator database 305 in step B). In this way the control device 100 will find out if there is already an existing control device 100 for the user device 600 in the same radio access network.

If there is no other instance of a control device 100 for the user device ID the control device 100 registers its address in the locator database at step E). If the control device 100 discovers that there is already a control device 100 for the user device ID the control device 100 will communicate with the discovered control device 100 to determine if they are control devices 100 for the same user device 600, or if there is a collision between the user device IDs at step C).

The control device 100 will also proceed to decide which control device 100 shall be responsible for the user device 600, and update the locator database 305 so that the right address is stored at step D).

If there are higher tiers in the hierarchical locator database 305 which contain a control device 100 for the user device ID, the higher tier will also be updated with an address to the additional control device 100 at step F). The purpose of the higher tiers of the database is to allow the control device 100 to be found by entities outside the scope of the radio access network. This increases the flexibility of the placement of control devices beyond the scope of a single access network, for example control devices can be located in the service providers network domain.

FIG. 8 shows a wireless communication system 700 according to an embodiment of the present invention. The embodiment is for the case when the control decision is a mobility decision for a user device 600. Hence, the control device 100 may in this embodiment be denoted a mobility control device 100.

With reference to FIG. 8 the SP tracks the user device 600 as it moves in a geographical area that is covered by many different radio access networks 500a, 500b, . . . 500n, e.g. operated by different Access Operators (AOs). The SP is aware of the rough position of the user device 600 and the radio access networks 500a, 500b, . . . 500n that operate in this area (this information may be in a SP database). To help control the user device mobility through these different radio access networks 500a, 500b, . . . 500n, the following events take place to move the user plane of the user device 600 from one radio access network 500 to another.

The SP sends a mobility control device 100 to be run by the network controllers 501a, 501b of the radio access network(s) 500 where the user device 600 is likely to visit (however only one radio access networks 500 is shown in FIG. 8). The SP issues sufficient certificates for the mobility control device 100 to be from a trusted party and safe to run.

The SP sends the user device 600 information of the radio access network(s) 500 in that area which have the proper mobility control device 100 running.

The mobility control device 100 running in the serving radio access network 500 (i.e. a serving mobility control device 100) is in constant communication with the user device 600 for the purpose of receiving location information from the user device 600, received signal quality measurements, or any other information that would help the mobility control devices 100 to identify user device locations and make mobility decisions for the user device 600. The serving mobility control device 100 also estimates user location and sends this information to the SP and optionally to the mobility control devices 100 running in neighbouring networks controllers. The communication between different mobility control devices (however only one mobility control device is shown in FIG. 8) occurs through interfaces between the network controllers of the different radio access networks 500. Some aspects of these interfaces, for instance, the identification of mobility control device 100 and radio access networks, security, communication establishment and the transportation of transparent containers may be standardized so as to support data exchange so the communicating entities can include whatever information they like. Data exchange may also be performed by means of normal inter-process connectivity between the entities.

Based on the user location, instantaneous Quality-of-Service (QoS) level experienced by the user device, measurements done by the network nodes, information collected from the neighbouring networks' mobility control devices, or any possible constraints the SP has given to the mobility control device 100 (any or all of the preceding), the serving mobility control device 100 takes the decision to handover the user device 600 to another radio access network 500. The decision is taken based on knowledge of at least two radio access networks that the user device 600 can connect to, with some indication of the quality it will receive from the respective radio access networks.

If there is no mobility control device 100 for the user device 600 already available in the target radio access network a new mobility control device 100 instance for the user device 600 may need to be instantiated. If the new instance is initiated in the network controller 501b it will be allocated a network address in that network controller (illustrated as 501a and 501b in FIG. 8) and generate a registration message containing the network address. The registration message will be sent in a registration signal S2b to the network device 300 containing the locator database 305. In general the registration signals S2a, S2b are sent when a mobility control device 100 is configured to handle mobility control functions for a user device 600, hence the S2a message would be sent when the mobility control device 100 in network controller 501a is configured to handle the user device 600. In some embodiments the mobility control device 100 may also send a further signal to the network device 300 with the locator database 305 to de-register its address for a user device 600 when it does no longer handle that user device 600.

The previous serving mobility control device 100 and a new serving mobility control device (not shown in FIG. 8) reconfigure the user plane, possibly in collaboration with the SP. As the mobility control devices are local, they take care of fast decision. Slower handover decisions can be made by the SP, or handled through constraints the mobility control devices are provided with by the SP. At any time the mobility control device 600 may also monitor the energy levels of user device batteries and make a control decision to handover to radio access network(s) 500 with lower energy consumption rates per bit.

In another embodiment of the present invention, a control device 100 can be mobile by creating a replica of itself in a new location in the radio access network 500 and then stop and remove the process in the previous location, hence effectively traverse the radio access network 500 following the user device 600 through its path of serving operators.

In one possible implementation of the handover preparation the mobile control device 100 clones itself and sends the clones to the neighbouring network nodes that may belong to the current or different AO. The identification of the neighbouring network nodes may be provided by SP or the serving AO as part of an Automatic Neighbour Relation function. Upon their arrival at the neighbouring network nodes the control device 100 clones may monitor user device 600 and prepare for a handover. In order to determine the best target AO, the control device 100 clones may communicate to each other and/or to their controlling SP the signal strength (or other relevant link quality or QoS parameters) of the user device 600 and their hosting AO. Handover process can be performed by means of a negotiation between the mobility control device 100 clones and/or the SP and the AO.

FIG. 9 illustrates an example of an embodiment of a wireless communication system 700 according to the present invention. The user device 600 is being provided services from the service provider SP which has connections to three different access networks in this example, AO1, AO2 and AO3 (the “data” arrows in FIG. 9 illustrate the direction of the data plane). The user device 600 is connected to a base station belonging to AO1, and therefore the data plane is routed through AO1. The control device 100a is classified as the operating control device, which has the immediate responsibility to handle the user device 600. Two more control devices 100b and 100c are acting for the user device 600 in this example, 100b in the access network AO2 is in the process of preparing a handover for the user device 600 to AO2. The control device 100c is negotiating with the network control entities on behalf of the user device 600 with the purpose to evaluate a possible future handover to the access network AO3. When the handover of the user device 600 to AO2 is completed the control device 100b will take over as operating control device for the user device 600.

One advantage of having mobility control devices 100 running in AO is twofold:

Allows SP logic to run at AO access network or anywhere in the cloud.

Reduces much of the control signalling to happen in the radio access network.

For the latter case, handover signalling happens in an intra-ANd and inter-ANd manner (where ANd denotes an Access Point (AP), such as eNB, WIFi AP, etc.). The former implies that AOs do not perform Radio Resource Management (RRM) rather the RRM is the outcome of a negotiation between mobility control devices 100a, 100b, . . . , 100n and between mobility control devices 100a, 100b, . . . , 100n and AOs as in a market-based programming solution. Since mobility control devices 100a, 100b, . . . , 100n negotiate on behalf of their SPs and the user device 600, any RRM function, such as QoS, mobility etc., is a negotiation between mobility control devices 100a, 100b, . . . , 100n which is performed locally in the ANd (or any node that controls mobility and RRM) of an AO.

In other words, the control device 100 carries the policies of a SP, and it aims at negotiating and running in the AO's network the policies of its SP. It is then assumed that an AO provides a basic RRM functionality service platform (a set of interfaces and lower-level RRM services/functions provided through them) that effectuates the results e.g. it provides a user scheduler that schedules user devices based on the outcome of negotiations. It has to be noted that in the case of a physical transition of the control devices 100a, 100b, . . . , 100n to the neighbouring ANds, this transition should be added to the signalling overhead. On the other hand the total network signalling between the control device 100 and SP is significantly reduced since the control device 100 carries SP's operation logic and runs it locally without instruction messages from the SP. The signalling can be further minimized if an SP has a control device 100 permanently installed in the AOs platform. The control device 100 can be inactive if no user devices of the SP are present; otherwise it gets activated to serve the SP's user devices. The control device 100 transition between the SP and the ANd may then happen only once in the beginning and later on whenever a new update of the control device 100 is available by the SP. Such a solution may have an impact on the business model as well. The transition is the movement of the control device 100 (software agent). As a minimum embodiment this would mean initiation of a software process (i.e. the control device) in a network controller.

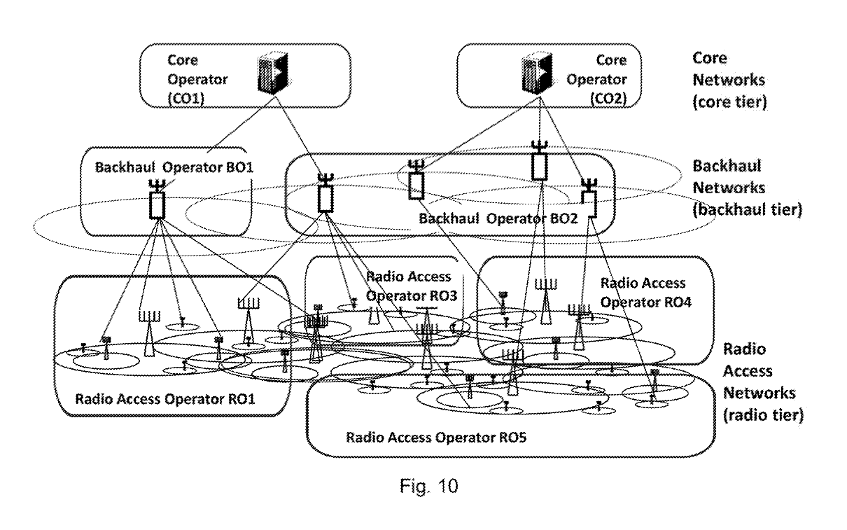

Depending on the type of the radio access network 500 deployed an AO may have three different roles each defining its own business entity and model. As illustrated in FIG. 10, the access operator can be:

A Core Network Operator (CNO), providing core network services; and/or

A (wireless or wired) Backhaul Network Operator (BNO), providing backhaul infrastructure and services to connect the access nodes to the core network; and/or

A radio access operator, providing wireless access connection and transmission services.

The end-to-end service is delivered through all three types of mentioned networks. When the different networks are controlled by different operators the data plane needs to be configured consistently over the borders of the different operator domains. With the flexible placement of the control devices 100 (not shown in FIG. 10) it is possible to achieve a tight integration by deploying control devices handling the traffic of a specific user device 600 not shown in FIG. 10) across the multiple networks. In today's radio access networks, AOs maintain all three roles and provide core, backhaul and radio access in an integrated radio access network where the radio access network and user management are tightly coupled.

Furthermore, any method according to the present invention may be implemented in a computer program, having code means, which when run by processing means causes the processing means to execute the steps of the method. The computer program is included in a computer readable medium of a computer program product. The computer readable medium may comprises of essentially any memory, such as a ROM (Read-Only Memory), a PROM (Programmable Read-Only Memory), an EPROM (Erasable PROM), a Flash memory, an EEPROM (Electrically Erasable PROM), or a hard disk drive.

Moreover, it is realized by the skilled person that the present control device and network device comprises the necessary communication capabilities in the form of e.g., functions, means, units, elements, etc., for performing the present solution. Examples of other such means, units, elements and functions are: processors, memory, buffers, control logic, encoders, decoders, rate matchers, de-rate matchers, mapping units, multipliers, decision units, selecting units, switches, interleavers, de-interleavers, modulators, demodulators, inputs, outputs, antennas, amplifiers, receiver units, transmitter units, DSPs, MSDs, TCM encoder, TCM decoder, power supply units, power feeders, communication interfaces, communication protocols, etc. which are suitably arranged together for performing the present solution.

Especially, the processors of the present devices may comprise, e.g., one or more instances of a Central Processing Unit (CPU), a processing unit, a processing circuit, a processor, an Application Specific Integrated Circuit (ASIC), a microprocessor, or other processing logic that may interpret and execute instructions. The expression “processor” may thus represent a processing circuitry comprising a plurality of processing circuits, such as, e.g., any, some or all of the ones mentioned above. The processing circuitry may further perform data processing functions for inputting, outputting, and processing of data comprising data buffering and device control functions, such as call processing control, user interface control, or the like.

Finally, it should be understood that the present invention is not limited to the embodiments described above, but also relates to and incorporates all embodiments within the scope of the appended independent claims.

What is claimed is:

1. Control device for a wireless communication system (700), the control device (100) comprising a processor (101) and a transceiver (103);
wherein the transceiver (103) is configured to receive a network address signal S₁ comprising an assigned network address for the control device (100) in a radio access network (500);
wherein the processor (101) is configured to generate a registration message indicating the assigned network address for the control device (100) and one or more network identities for a user device (600) connected to the radio access network (500);
wherein the transceiver (103) further is configured to transmit a registration signal S₂ comprising the registration message to a network device (300),
receive a user information signal S₃ at the assigned network address, the user information signal S₃ comprising network operation information for the user device (600); and
wherein the processor (101) further is configured to determine a network control decision for the user device (600) based on the network operation information.

2. Control device according to claim 1, wherein the processor (101) further is configured to determine the network control decision by executing a control algorithm.

3. Control device (100) according to claim 2, wherein the transceiver (103) further is configured to receive a first control signal from a service provisioning device (505), wherein the first control signal comprises control instructions for the execution of the control algorithm.

4. Control device (100) according to claim 1, wherein the control decision is a mobility decision for the user device (600).

5. Control device (100) according to claim 1, wherein the transceiver (103) further is configured to transmit a second control signal to a network controller (501) of the radio access network (500) or to the user device (600), the second control signal comprising the control decision for the user device (600).

6. Control device (100) according to claim 1, wherein the network operation information for the user device (600) is one or more in the group comprising: network location information, positioning information for the user device (600), radio channel measurement information, channel quality information, battery state information of the user device (600), quality of service information for the user device (600), charging information, encryption information, authentication information, and network mobility policy information.

7. Network device for a wireless communication system (700), the network device (300) comprising a processor (301), a transceiver (303) and a database (305);
wherein the transceiver (303) is configured to receive a registration signal S₂ comprising a registration message indicating a network address of a control device (100) for a user device (600) and one or more network identities of the user device (600); and
wherein the processor (301) is configured to update a database object for the user device (600) in the database (305) with the registration message.

8. Network device (300) according to claim 7, wherein the processor (301) further is configured to use the one or more network identities of the user device (600) as lookup indices in the database (305).

9. Network device (300) according to claim 7, wherein the database object in the database (305) further comprises
a first database entry indicating the network address of the control device (100), and
a second database entry indicating a mobility anchor point of the user device (600).

10. Network device (300) according to claim 9, wherein the database object further comprises
a third database entry indicating an identity associated with a control plane of the user device (600), and
a fourth database entry indicating an identity associated with a data plane of the user device (600).

11. Network device (300) according to claim 10, wherein the fourth database entry is an encrypted identity of the user device (600).

12. Network device (300) according to claim 7, wherein the network address of the control device (100) comprises an IP-address and a transport layer port number.

13. Method for a wireless communication system (700), the method (200) comprising:
receiving (201) a network address signal S₁ comprising an assigned network address for the control device (100) in a radio access network (500);
generating (203) a registration message indicating the assigned network address for the control device (100) and one or more network identities for a user device (600) connected to the radio access network (500);
transmitting (205) a registration signal S₂ comprising the registration message to a network device (300),
receiving (207) a user information signal S₃ at the assigned network address, the user information signal S₃ comprising network operation information for the user device (600);
determining (209) a network control decision for the user device (600) based on the network operation information.

14. Method for a wireless communication system (700); the method (400) comprising receiving (401) a registration signal S₂ comprising a registration message indicating a network address of a control device (100) for a user device (600) and one or more network identities of the user device (600); and
updating (403) a database object for the user device (600) in the database (305) with the registration message.

15. Computer program with a program code for performing a method according to claim 13 when the computer program runs on a computer.
